(19) United States
(12) Patent Application Publication
(10) Pub. No.: US 2017/0209817 A1
(43) Pub. Date: Jul. 27, 2017

(54) INDUSTRIAL FILTERING DEVICE

(71) Applicant: Kenneth WONG, Zhubei City (TW)

(72) Inventor: Kenneth WONG, Zhubei City (TW)

(21) Appl. No.: 15/398,062

(22) Filed: Jan. 4, 2017

(30) Foreign Application Priority Data
Jan. 21, 2016 (TW) 105200913

(51) Int. Cl. B01D 29/33; B01D 36/00; B01D 39/16

(52) U.S. Cl. CPC B01D 29/333; B01D 39/16; B01D 36/001; B01D 2201/306

(57) ABSTRACT

An industrial filtering device is provided, including a shell body, having a receiving space, an outlet portion and an inlet portion, the outlet portion and the inlet portion respectively communicating with the receiving space, the inlet portion and the outlet portion defining a flow passage therebetween; a filter, including a PP filter material, the filter received in the receiving space and laterally arranged in the flow passage, the filter being pre-wetted and having an outer diameter which is between 75 mm to 88 mm.

### BACKGROUND OF THE INVENTION

Field of the Invention

The present invention relates to a filtering device, and more particularly to an industrial filtering device.

Description of the Prior Art

Generally, a filtering device as disclosed in TWM492187 at least includes an outer shell, an inner shell and at least one filter material, the filter material is arranged between the outer shell and the inner shell, the outer shell has at least one inlet opening, and the inner shell has at least one outlet opening.

However, the filter material mentioned above is tightly arranged, and when a filtering fluid flows through the filter material, particles in smaller sizes may break through a restriction of pores of the filter material and penetrate the filter material because a pressure suddenly rises; therefore, particles in greater sizes cannot be effectively filtered. In addition, a common filter material must be replaced frequently to maintain a filtering quality, so costs of components increase. Hence, to effectively elevate a filtering efficiency of the filtering device to provide a preferable filtering quality is the goal that the present invention wants to work toward.

The present invention has arisen to mitigate and/or obviate the afore-described disadvantages.

### SUMMARY OF THE INVENTION

The major object of the present invention is to provide an industrial filtering device which can effectively filter out impurities and allows grinding particles to pass therethrough to provide a preferable filtering efficiency. In addition, a service life of the industrial filtering device is effectively increased, and time needed for initiating the device and waste of a filtering fluid are decreased. The industrial filtering device is further sterilized to prevent bacteria from influencing a filtering quality.

To achieve the above and other objects, an industrial filtering device is provided, including a shell body, having a receiving space, an outlet portion and an inlet portion, the outlet portion and the inlet portion respectively communicating with the receiving space, the inlet portion and the outlet portion defining a flow passage therebetween; a filter, including a PP filter material, the filter received in the receiving space and laterally arranged in the flow passage, the filter being pre-wetted and having an outer diameter which is between 75 mm to 88 mm.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing a preferred embodiment of the present invention;

FIG. 2 is a cross-sectional view of the preferred embodiment of the present invention;

FIG. 3 is a drawing showing experimental results of the preferred embodiment of the present invention;

FIG. 4 is a drawing showing another experimental results of the preferred embodiment of the present invention; and

FIG. 5 is a drawing showing still another experimental results of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

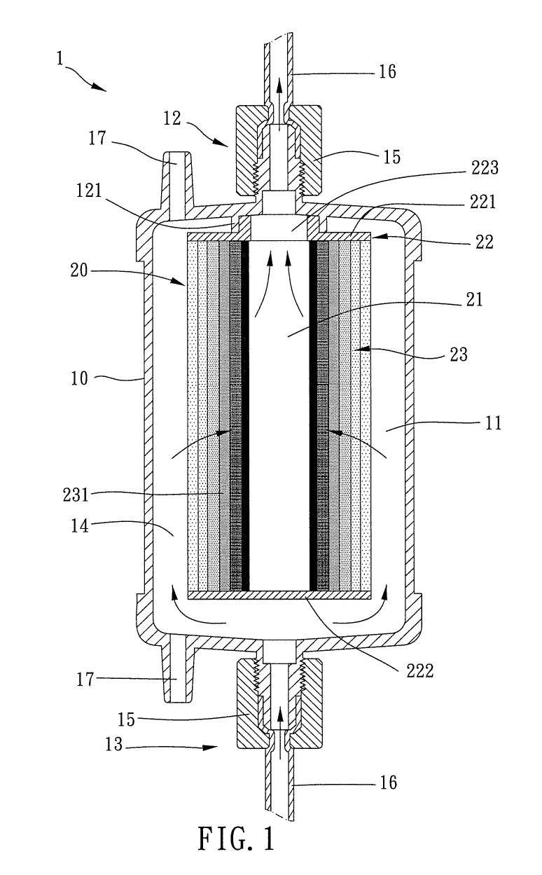

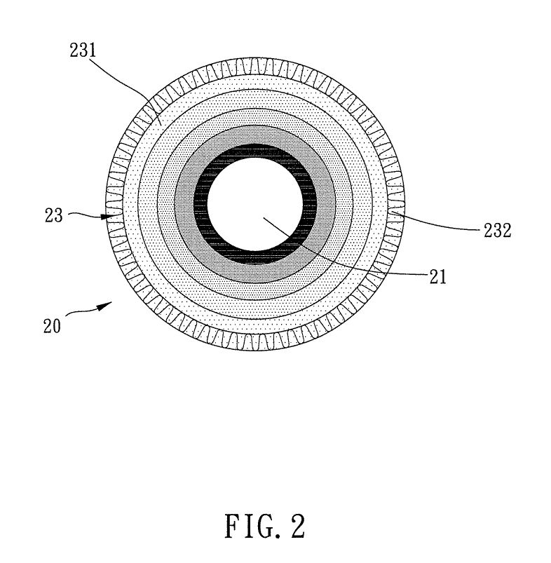

Please refer to FIGS. 1 and 2 for a preferred embodiment of the present invention. An industrial filtering device 1 includes a shell body 10 and a filter 20.

The shell body 10 has a receiving space 11, an outlet portion 12 and an inlet portion 13, the outlet portion 12 and the inlet portion 13 respectively communicate with the receiving space 11, the inlet portion 13 and the outlet portion 12 define a flow passage 14 therebetween, and the inlet portion 13 and the outlet portion 12 are respectively for a filtering fluid to be imported and exported therethrough. For example, the inlet portion 13 and the outlet portion 12 respectively include an expanded tube connector 15, each said expanded tube connector 15 is for being liquid-tightly connected to a tube member 16, the shell body 10 has at least one air-exhausting hole 17 respectively facingly neighboring to the outlet portion 12 and the inlet portion 13, and the air-exhausting hole 17 communicates with the receiving space 11.

The flow passage 14 is for the filtering fluid to flow therethrough and flow from an exterior of the filter 20 toward an interior of the filter 20 so as to filter out impurities, the filtering fluid may be a slurry, and in other embodiments, the filtering fluid may flow from the interior of the filter 20 toward the exterior of the filter 20 so as to filter out impurities.

Specifically, the filter 20 is substantially cylindrical, the filter 20 includes a PP filter material, the filter 20 is received in the receiving space 11 and laterally arranged in the flow passage 14, the filter 20 is pre-wetted and has an outer diameter which is between 75 mm to 88 mm. More specifically, for example, the filter 20 is wetted by a pre-wetting fluid, the filter 20 which is wetted is flushed by deionized water, and the pre-wetting fluid may be hydrophilic, for example, combustible liquids, ethanol or isopropanol alcohol (IPA). More specifically, a part of the filter 20 includes the PP filter material, for example, the PP filter material may be partly circumferentially arranged, spacingly arranged or surroundingly arranged.

In addition, the filter 20 which is pre-wetted has a more stable and smaller pressure variation and has more stable and preferable retention efficiency for providing preferable filtering effect and quality stably and continuously; therefore, a service life of the filter 20 can be effectively elevated, a time of initiating the filter 20 can be saved and a waste of the filtering fluid is decreased. The filter 20 may be sterilized, for example, the filter 20 may be sterilized through high-temperature steam to prevent the filter 20 which is pre-wetted from being polluted by bacteria.

The filter 20 defines a channel 21 around an axial direction, and the channel 21 communicates with the inlet portion 13 or the outlet portion 12. For example, in this embodiment, the filter 20 has a cartridge member 22 and a filtering medium 23, at least one part of the filtering medium 23 has the PP filter material, the filtering medium 23 is arranged on the cartridge member 22 and surroundingly forms the channel 21, and the cartridge member 22 is assembled to the outlet portion 12. More specifically, the cartridge member 22 includes a lid member 221 and a side cover 222, the outlet portion 12 has an engaging portion 121 which is protrudingly disposed on an inner wall of the shell body 10, the lid member 221 is engaged with the engaging portion 121, the lid member 221 has a through hole 223 which communicates with the channel 21, and the side cover 222 is arranged facingly neighboring to the inlet portion 13 and blocks the channel 21 from communicating with the inlet portion 13. During a filtering operation, the filtering fluid flows from the inlet portion 13 into the receiving space 11 and is blocked by the side cover 222 so that the filtering fluid flows through the filtering medium 23 of the filter 20 into the channel 21, through the channel and toward the outlet portion 12 to be exported. Therefore, impurities in the filtering fluid can be completely filtered out so as to provide preferable filtering quality.

The filtering medium 23 includes a plurality of filtering layers 231, the filtering layers 231 are layered around the axial direction, and the filtering layers 231 are gradually smaller in pore size from outside to inside. More specifically, the filtering layers 231 include a folded layer 232, the filtering medium 23 has the folded layer 232 on an outer side thereof, the folded layer 232 is radially folded to and fro around the axial direction and continuously layered circumferentially, the folded layer 232 is used to filter out impurities in greater dimensions, at least one of the filtering layers 231 may be the PP filter material, and a nominal size of the PP filter material is equal to or smaller than 0.2 μm to filter out particles or impurities which are greater than 0.2 μm in size so that grinding particles smaller than 0.2 μm in size can pass the filtering layers 231 to provide preferable filtering efficiency.

It is to be noted that the channel 21 has an inner diameter which is substantially 25 mm so that the filter 20 has a predetermined thickness. Specifically, a ratio of the outer diameter of the filter 20 and an inner diameter of the channel 21 is greater than or equal to 3. For example, when the outer diameter of the filter 20 is 75 mm, the predetermined thickness is 25 mm, and the ratio of the outer diameter of the filter 20 and the inner diameter of the channel 21 is 3. More preferably, when the filter 20 has a greater outer diameter (the ratio of the outer diameter of the filter 20 and the inner diameter of the channel 21 is greater than 3), the filter 20 has a greater filtering surface area, and the filtering efficiency can be effectively elevated.

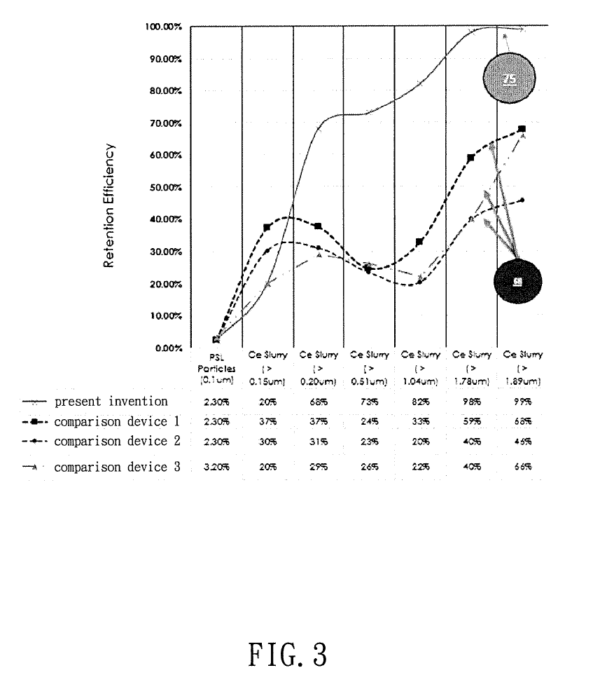

Please refer to FIGS. 3 to 5 for experimental results of the filter 20. A comparison of the retention efficiency of the filter 20, a comparison device 1, a comparison device 2 and a comparison device 3 is shown in FIG. 3, and outer diameters of the comparison device 1, the comparison device 2 and the comparison device 3 are respectively 68 mm. As shown in FIG. 3, when a nominal size of particles in the filtering fluid is greater than 0.2 μm, the filter 20 of the present invention (which has the outer diameter of 75 mm) obviously has more stable and greater retention efficiency and can filter out impurities. When the nominal size of the particles in the filtering fluid is smaller than 0.2 μm, the filter 20 of the present invention obviously has smaller retention efficiency and allows the grinding particles to pass therethrough. Therefore, compared with the comparison device 1, the comparison device 2 and the comparison device 3, the filter 20 of the present invention is for the filtering fluid to proved preferable filtering effect and quality in actual practice.

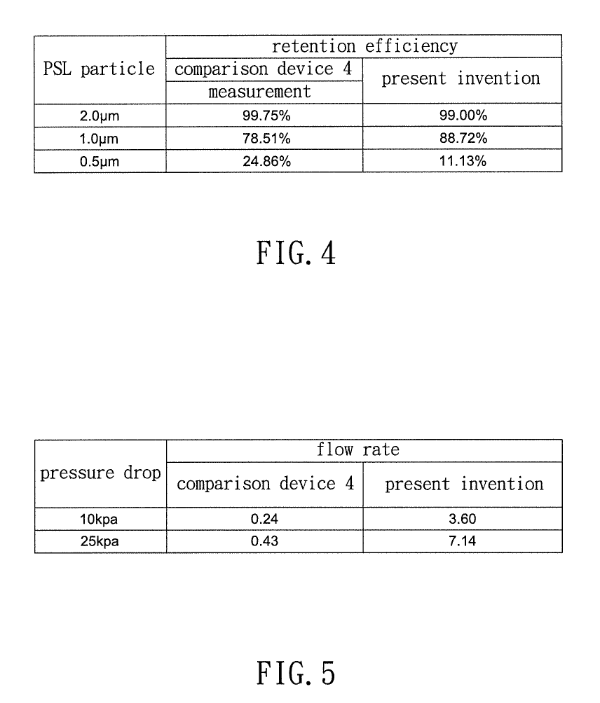

A comparison of the retention efficiency of the filter 20 and a comparison device 4 is shown in FIG. 4. When a nominal size of PSL (polystyrene latex) particles is 0.5 μm, compared with the comparison device 4, the filter 20 of the present invention obviously has smaller retention efficiency and allows the PSL particles to pass therethrough.

A pressure drop and a flow rate between the filter 20 and the comparison 4 are shown in FIG. 5. When the pressure drop is 25 Kpa, compared with the comparison device 4, the filter 20 of the present invention has a more preferable flow rate, so the filter 20 can provide preferable filtering efficiency and allows the filtering fluid to flow through the filter 20 stably to provide preferable filtering effect and quality.

The industrial filtering device can effectively filter out impurities or particles and allows the grinding particles to pass therethrough to provide the most preferable filtering efficiency. In addition, the service life of the industrial filtering device is effectively increased, and time needed for initiating the device and waste of the filtering fluid are decreased. The industrial filtering device is further sterilized to prevent bacteria from influencing the filtering quality.

While we have shown and described various embodiments in accordance with the present invention, it should be clear to those skilled in the art that further embodiments may be made without departing from the scope of the present invention.

What is claimed is:

1. An industrial filtering device, including:
a shell body, having a receiving space, an outlet portion and an inlet portion, the outlet portion and the inlet portion respectively communicating with the receiving space, the inlet portion and the outlet portion defining a flow passage therebetween;
a filter, including a PP (polypropylene) filter material, the filter received in the receiving space and laterally arranged in the flow passage, the filter being pre-wetted and having an outer diameter which is between 75 mm to 88 mm.

2. The industrial filtering device of claim 1, wherein the flow passage is for a filtering fluid to flow therethrough and flow from an exterior of the filter toward an interior of the filter.

3. The industrial filtering device of claim 1, wherein the filter defines a channel around an axial direction, and the channel communicates with the inlet portion or the outlet portion.

4. The industrial filtering device of claim 3, wherein the channel has an inner diameter which is substantially 25 mm.

5. The industrial filtering device of claim 3, wherein a ratio of the outer diameter of the filter and an inner diameter of the channel is greater than or equal to 3.

6. The industrial filtering device of claim 3, wherein the filter has a cartridge member and a filtering medium, at least one part of the filtering medium has the PP filter material, the filtering medium is arranged on the cartridge member and surroundingly forms the channel, and the cartridge member is assembled to the outlet portion.

7. The industrial filtering device of claim 6, wherein the cartridge member includes a lid member and a side cover, the outlet portion has an engaging portion which is protrudingly disposed on an inner wall of the shell body, the lid member is engaged with the engaging portion, the lid member has a through hole which communicates with the channel, and the side cover is arranged facingly neighboring to the inlet portion and blocks the channel from communicating with the inlet portion.

8. The industrial filtering device of claim 6, wherein the filtering medium includes a plurality of filtering layers, the filtering layers are layered around the axial direction, and the filtering layers are gradually smaller in pore size from outside to inside.

9. The industrial filtering device of claim 8, wherein at least one of the filtering layers is made of the PP filter material, and a nominal pore size of the PP filter material is equal to or smaller than 0.2 μm.

10. The industrial filtering device of claim 6, wherein the inlet portion and the outlet portion respectively include an expanded tube connector, each said expanded tube connector is for being liquid-tightly connected to a tube member, the filter is substantially cylindrical, the filtering medium has a folded layer on an outer side thereof, the folded layer is radially folded to and fro around the axial direction and continuously layered circumferentially, and the filter is sterilized.
